(19) United States
(12) Patent Application Publication
(10) Pub. No.: US 2006/0071881 A1
(43) Pub. Date: Apr. 6, 2006

(54) Line-at-a-time addressed display and drive method

(75) Inventors: Dirk De Bruin, Eindhoven (NL); Roel Van Woudenberg, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/540,708

(22) PCT Filed: Dec. 10, 2003
(86) PCT No.: PCT/IB03/06068

§ 371 Date: Jun. 24, 2005

(30) Foreign Application Priority Data
Dec. 30, 2002 (EP) 02080582.6

(51) Int. Cl. G09G 3/22

(52) U.S. Cl. 345/75.2

(57) ABSTRACT

A display device having a set of non-pixel-selective electrodes (1a, 1b) and a set of pixel-selective electrodes (2a, 2b, 2c), so that pixels (15) are defined by intersections of said electrodes. The display further comprises means (3, 4a, 4b, 5, 6, 7) for applying an amplitude modulated (AM) signal to a non-pixel-selective electrode (1a, 1b), and means (10a, 10b, 11, 13) for applying a pulse width modulated (PWM) signal to a pixel-selective electrode (2a, 2b, 2c). The voltage difference between the electrodes defines the light intensity which can be emitted, and the available intensity varies in time according to the AM signal. The width of the pulse on the pixel-selective electrode represents the duration of light emission, and thus the gray level of the corresponding pixel. The combination of the two generates an exponentially distributed emitted light intensity, enabling gamma correction.

The present invention relates to display devices comprising a set of non-pixel-selective electrodes, and a set of pixel-selective electrodes, pixels being defined by intersections of said electrodes. The invention also relates to a method for driving such a display.

In displays of the above kind each “non-pixel-selective” electrode is connected to several pixels, typically an entire line (or row) of pixels, while the “pixel-selective” electrodes intersect the non-pixel-selective electrodes and thus can select one of the pixels in the line. Such displays are generally referred to as being addressed “line-at-a-time” or “row-at-a-time”.

An example of displays of the above kind are field emission displays (FED). For such displays, known driving methods can be categorized as pulse width modulation (PWM) and pulse amplitude modulation (PAM).

With pulse width modulation, the pixels are selected one row at a time by applying a positive voltage pulse to that row. The length of this pulse is equal for all rows and often equal to the line time. During the positive pulse on the row electrodes, a negative pulse is applied to all column electrodes. The widths of these pulses represent the gray levels of the corresponding pixels. The advantage of pulse width modulation is that it is relatively easy and cheap to implement. However, it is impossible to implement full range gamma correction with pure pulse width modulation, since this would require pulse width's in the order of nano seconds, which is physically impossible.

With pulse amplitude modulation, the rows are selected in a similar way as with pulse width modulation. However, at the column electrodes, pulses of fixed width are applied. Now the amplitudes of the pulses are modulated to produce different gray levels. In this way, the IV-characteristic of the emitters, which is close to a gamma curve, is used, so that gamma correction is easy to implement. However, pure pulse amplitude modulation requires a digital to analog converter for each column, which is expensive.

An improved modulation technique was disclosed in U.S. Pat. No. 5,701,134. According to this technique, the pulse on the column electrodes has a predetermined amplitude modulated shape (e.g. a descending function), and is then pulse width modulated. This combination of pulse width modulation and amplitude modulation on the column electrodes makes it possible to achieve gamma correction, while only requiring one D/A-converter.

However, the technique described in U.S. Pat. No. 5,701,134 requires applying the truncated amplitude modulated signal to all columns. Therefore, the capacitance of the entire display will have to be driven by the signal generator, at least during the first part of the line time (before any pulses have been truncated).

It is an object of the present invention to provide an improved way to combine pulse width modulation and amplitude modulation of a line-at-a-time addressed display, overcoming the problems mentioned above.

This object is achieved by a display device of the kind mentioned in the introductory paragraph, further comprising means for applying an amplitude modulated (AM) signal to a non-pixel-selective electrode, and means for applying a pulse width modulated (PWM) signal to a pixel-selective electrode.

The object is also achieved by a method of the kind mentioned by way of introduction, wherein an amplitude modulated (AM) signal is applied to a non-pixel-selective electrode, and a pulse width modulated (PWM) signal is applied to a pixel-selective electrode.

According to the invention, the AM signal is thus connected to one electrode and a PWM pulse is applied to another electrode intersecting the first electrode, thereby activating a pixel in the intersection of the electrodes.

As the AM signal is applied only to one of the non-pixel-selective electrodes at a time, the signal generator only has to drive the capacitive load of one row (or column) of the display.

The voltage difference between the electrodes defines the light intensity which can be emitted, and the available intensity varies in time according to the AM signal. The width of the pulse on the pixel-selective electrode represents the duration of light emission, and thus the gray level of the corresponding pixel. The combination of the two generates an exponentially distributed emitted light intensity, enabling gamma correction.

While the technique described in U.S. Pat. No. 5,701,134 can be described as a multiplication of AM and PWM on a single electrode, the present invention is better described as an in-pixel convolution of AM and PWM on two intersecting electrodes.

The means for applying the AM signal can comprise a memory unit for storing a predefined amplitude curve, for application to the electrodes. It can also comprise analogue electronics, such as linear or exponential ramps, sine curves, etc.

Preferably, non-pixel-selective electrodes are the row electrodes of the display, so that the AM signal is applied to the row electrodes. As amplitude modulation requires D/A conversion it is more expensive than binary modulation, and it is therefore advantageous to amplitude modulate the rows, which (especially in a high aspect ratio color display) are much fewer than the columns. Also, in this case, the column drivers can be essentially conventional PWM column drivers, and do not require extensive redesign.

According to a preferred embodiment, each pixel comprises a field emitter connected to a pixel-selective electrode, and wherein the non-pixel-selective electrode acts as a gate electrode.

The AM signal can be increased from a threshold value to a maximum value during a line period. The PWM pulse on the pixel-selective electrode is then arranged to activate the pixel during a predetermined time starting from the beginning of the line period. The threshold value is the lowest value that will cause emission of light from the pixel, and the maximum value is determined by the shape of the amplitude curve of the signal, and by the PWM pulse amplitude.

Alternatively, the AM signal starts at the maximum value and decreases to the threshold value. The pulse on the pixel-selective electrode is then accordingly shifted to the end of the line period.

The amplitude curve of the amplitude modulated signal can further be alternated between consecutive line periods, for example, the maximum value can be different. As a further example, the signal can increase during one line period and decrease during the next. This allows for an implementation that reduces power dissipation, as in the back-to-back scheme described in U.S. Pat. No. 5,689,278.

The amplitude curve of the amplitude modulated signal can further be alternated between different frames. By combining line alteration and frame alternation in a suitable way, line dithering can be achieved, generating additional grey levels.

According to one embodiment of the invention, the PWM signal is applied to the pixel-selective electrode first, and the AM signal is applied to the non-pixel-selective electrode a short time period later, when the rise-time of the pulse width modulated signal has passed. The pulse width modulated signal can thereby attain its peak level before the pixel is activated, allowing for very short pulses, independent of pulse rise time.

These and other aspects of the invention will be apparent from the preferred embodiments more clearly described with reference to the appended drawings.

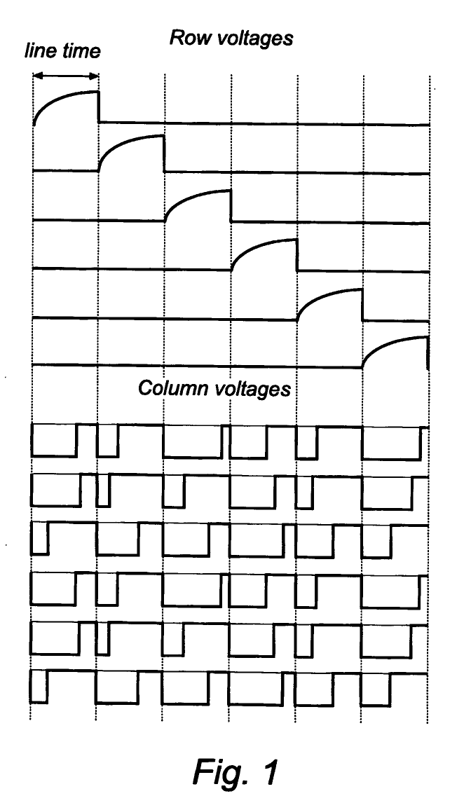

FIG. 1 shows examples of row and column voltages according to a first embodiment of the invention.

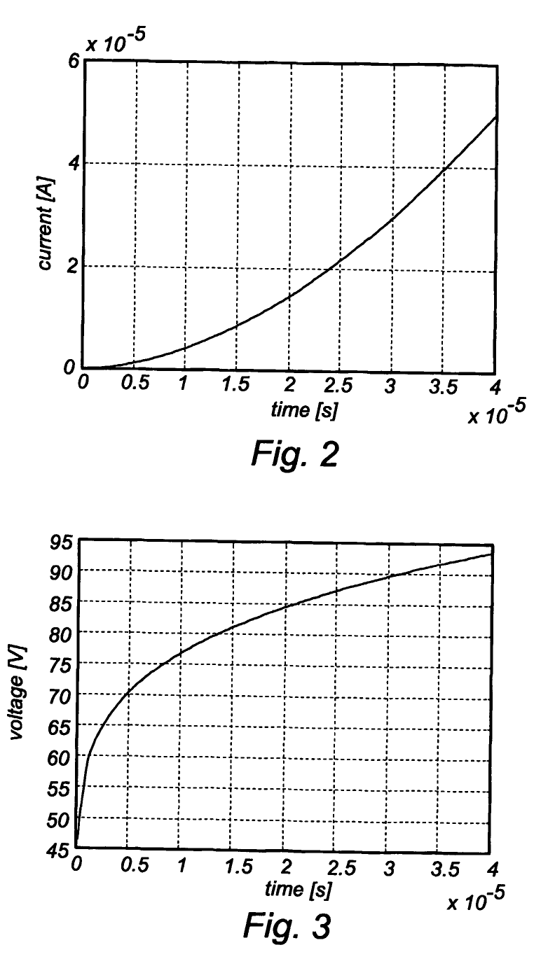

FIG. 2 shows an example of the emitter current as a function of time.

FIG. 3 shows an example of the gate-emitter voltage as a function of time.

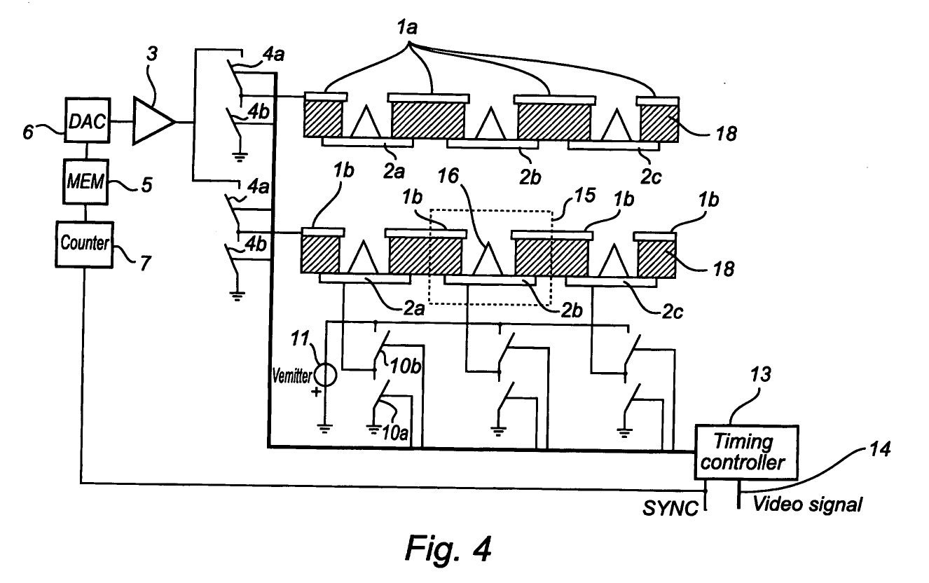

FIG. 4 is a schematic block diagram of a field emission display according to the first embodiment of the invention.

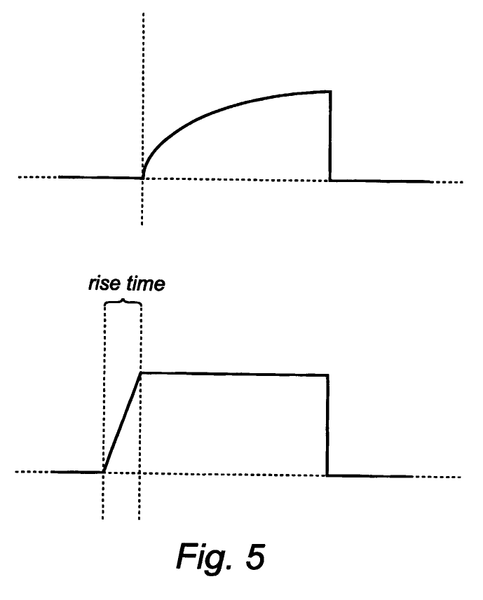

FIG. 5 illustrates delaying the AM signal compared to the PWM pulse.

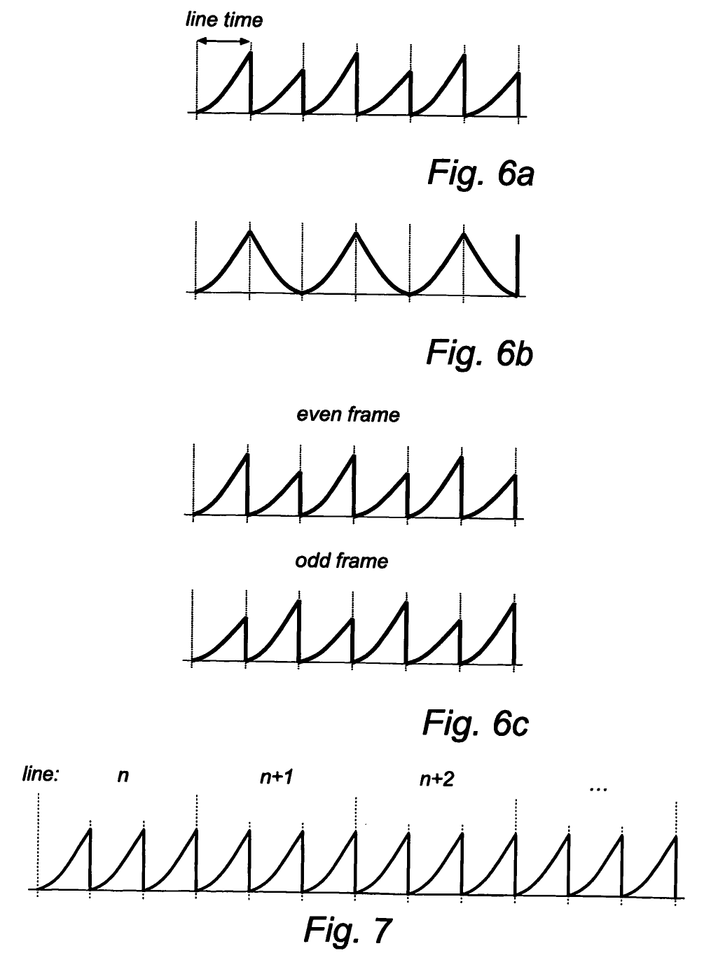

FIGS. 6a, 6b and 6c illustrate alternative amplitude curves.

FIG. 7 shows amplitude modulation in case of color sequential driving.

The general principle of the invention is illustrated in FIG. 1, which shows the behavior of row and column voltages when driving a display according to a first embodiment of the invention. As is clear from the figure, the non-pixel-selective signal (which is the row voltage in the illustrated case), is a steadily increasing positive voltage. The pixel-selective signal (which is the column voltage in the illustrated case) is a negative voltage pulse starting at the beginning of the line period, and with a duration corresponding to the desired gray level.

The shape of the amplitude modulated signal in the current controlled case can be determined by starting from the required emitter current of the FED pixel, defined by

$$i ( t ) = \frac{ⅆ Q}{ⅆ t} , \qquad ( 1 )$$

where Q is the total amount of charge that reaches the phosphor screen at time between the beginning of the line period and t. When gamma correction is used, Q can be written as

$$Q = {{Q}_{max} ( \frac{t}{{T}_{line}} )}^{γ} , \qquad ( 2 )$$

where Qₘₐₓ denotes the charge for the highest gray level and Tₗᵢₙₑ is the line time. Differentiating this equation with respect to time yields for the emitter current

$$i ( t ) = γ {Q}_{max} \frac{{t}^{γ - 1}}{{T}_{line}^{γ}} . \qquad ( 3 )$$

As an example, FIG. 2 shows a plot of equation (3) in case of the maximum gray level. For this plot, the line time was equal to 40 μs (i.e. 500 rows at 50 Hz). Qₘₐₓ was equal to 80.10⁻¹² C and gamma equaled 2.8.

In case of voltage control the same current should flow. The gate-emitter voltage V_{ge} required to let this current flow can be calculated by solving for V_{ge} in
I=αV_{ge}²e^{-βIV}^{_{ge}}. (4)

In this equation, a and b are constants of the emitters. FIG. 3 shows an example of V_{ge} as function of time for the maximum gray level. For this plot, a and b were set to 1.10⁻⁴ A/V² and 900 V respectively. FIG. 3 illustrates the general shape of the voltage signal in FIG. 1.

The embodiment illustrated in FIG. 1 can be implemented as shown in FIG. 4. This figure shows a part of a FED comprising two row electrodes 1a, 1b and three column electrodes 2a, 2b, 2c. The electrodes are separated by a dielectric layer 18. In each intersection of the electrodes, a pixel 15 is formed by an array of field emitters tips (hereinafter referred to as a field emitter 16, shown schematically in FIG. 4 as one tip) located between the electrodes. The emitter 16 is connected to the column electrode 2b, and is arranged to emit electrons which are gathered by an anode (not shown). The anode is typically coated with a phosphor in order to generate light when electrons strike the anode. The row electrode 1b acts as a gate electrode, so that when a voltage is applied the row electrode 1b, exceeding the voltage applied to the column electrode 2b, the emitter 16 emits electrons.

The row electrodes 1a, 1b can be set high by connecting them to the output of an amplifier 3 with a switch 4a, or set low by connecting them to ground with a switch 4b. The curve as shown in FIG. 3 is stored in a memory 5, and a digital to analog converter 6 converts the output of the memory 5 to an analog signal, which is amplified by the amplifier 3. A counter 7 is used to address the memory cells of the memory 5, so that the output of the D/A-converter 6 looks like FIG. 3.

In a similar manner, the column electrodes 2a, 2b, 2c can be set low by connecting then to ground using switch 10a or set high by connecting them to a voltage source 11.

As mentioned above, when the column electrode of an emitter 16 is set low, while the row electrode of the same emitter 16 is set high, the pixel will be turned on and emit light with an intensity depending on the row-column voltage. When the emitter 16 is set high, the pixel will be turned off, regardless of the row setting (assuming, of course, that the amplitude modulated voltage applied to the row electrode never exceeds the voltage of the voltage source 11).

The switches 4a and 4b as well as the switches 10a and 10b are controlled by a timing controller 13. The timing controller 13 decides, based on the video information 14, which pixels have to be turned on or off, and when.

In case only an approximation of the gamma curve is required, the components 5, 6 and 7 can be replaced by an analog circuit, such as an analogue ramp or a simple RC network. In this case, a rough approximation for the gamma curve can be implemented with the network, while the exact gamma correction can be achieved using video correction in the digital domain, using a simple gray-to-gray look-up table.

In FIG. 4, each emitter 16 is connected to a column electrode 2a, 2b, 2c, while the row electrodes 1a, 1b act as gate electrodes. Naturally, the reverse is also possible, leading to amplitude modulation of the emitter voltages (which are now non-pixel-selective) and pulse width modulation of the gate voltages (which are now pixel-selective).

Further, in FIG. 4, the row electrodes are connected to the amplitude modulated signal, while the column electrodes are connected to the pulse width modulated signal. Again, the reverse is possible, but this would lead to the unconventional drive scheme of selecting a column at a time (with the amplitude modulated signal), and then selecting the pixels of that column with the pulse modulated row voltage. Also, column drivers with pulse width modulation are already available. Therefore, it is preferred to maintain the pulse width modulation on the columns. Further, the amplitude modulation requires a D/A-converter for each row or column. As a typical display contains considerably fewer rows than columns (e.g. 768 compared to 3072 in a standard XGA resolution color display), it will therefore be much less expensive to arrange the amplitude modulation on the rows.

Variations

The minimum required pulse width on the column electrodes equals
Tₘᵢₙ=Tₗᵢₙₑ/nₗₑᵥₑₗₛ, (5)
where nₗₑᵥₑₗₛ denotes the number of gray levels that have to be generated. In case of a line time of 40 μs and 256 gray levels, this yields a minimum pulse width of 156 ns. In case this is too small (e.g. due to electronics performance), the slope of the gate-emitter voltage, i.e. the slope of the row voltage signal in FIG. 3, can be made less steep in the beginning of the line period. In this way, the pulse widths for the lowest gray levels can be made wider. The consequence of this is that the increase in pulse width is not necessarily uniform for all gray levels, which is the case with the steeper slope.

The effect of the rise-time of the pulse on the column electrode can further be eliminated by starting the pulse earlier than the AM signal, so that the peak pulse voltage has already been attained when the row is connected to the amplitude modulated signal. This is illustrated in FIG. 5.

In the description above, the AM signal has been assumed to have the same amplitude curve for all line times. This is not necessary. Consecutive line times can have different amplitude curves, if this is deemed advantageous. For example, the maximum value of the signal may be different (FIG. 6a) or the slope of the amplitude curve can be alternating (FIG. 6b).

Also, the AM signals may be different for consecutive frames, if this is deemed advantageous. Such frame alteration can combined with the line time alterations, as illustrated in FIG. 6c. Such amplitude modulation can enable line dithering, with additional gray levels as a result.

In case of color sequential driving, each line is divided into three segments, one for each color, and the amplitude modulated signal can be of the form illustrated in FIG. 7. In this case, it is not necessary that each segment has identical amplitude curves, or, for that matter, time periods.

The above description has been directed solely to field emission displays. However, this is not a limitation of the present invention, which can be applied to any display which is addressed in a similar way as a FED, i.e. line-at-a-time. Examples of such displays are passive matrix PLED/OLED displays.

1. A display device having a set of non-pixel-selective electrodes (1a, 1b), and a set of pixel-selective electrodes (2a, 2b, 2c), pixels (15) being defined by intersections of said electrodes, characterized by means (3, 4a, 4b, 5, 6, 7) for applying an amplitude modulated (AM) signal to a non-pixel-selective electrode (1a, 1b), and means (10a, 10b, 11, 13) for applying a pulse width modulated (PWM) signal to a pixel-selective electrode (2a, 2b, 2c).

2. A display device according to claim 1, wherein said means for applying an AM signal comprises a memory (5) for storing a predefined amplitude curve.

3. A display device according to claim 1, wherein said means for applying an AM signal comprises analogue electronics.

4. A display device according to claim 1, wherein said non-pixel-selective electrodes (1a, 1b) are the row electrodes of the display.

5. A display device according to claim 1, wherein each pixel (15) comprises a field emitter (16) connected to a pixel-selective electrode (2a, 2b, 2c), and wherein the non-pixel-selective electrode (1a, 1b) acts as a gate electrode.

6. A method for driving a display device comprising a set of non-pixel-selective electrodes, and a set of pixel-selective electrodes, pixels being defined by intersections of said electrodes, characterized by:
applying an amplitude modulated (AM) signal to a non-pixel-selective electrode (1a, 1b), and
applying a pulse width modulated (PWM) signal to a pixel-selective electrode (2a, 2b, 2c).

7. A method according to claim 6, wherein the AM signal is increased from a threshold value to a maximum value during a line period.

8. A method according to claim 6, wherein the amplitude curve of the AM signal is alternated between consecutive line periods.

9. A method according to claim 8, wherein the AM signal is increased from a threshold value to a maximum value during one line period and decreased from said maximum value to said threshold value during the next consecutive line period.

10. A method according to claim 6, wherein the amplitude curve of the AM signal is alternated between consecutive frames.

11. A method according to claim 6, wherein the PWM signal is applied to said pixel-selective electrode first, and the AM signal is applied to said non-pixel-selective electrode when the rise-time of the PWM signal has passed.
